(19) United States
(12) Patent Application Publication
(10) Pub. No.: US 2013/0143005 A1
(43) Pub. Date: Jun. 6, 2013

(54) REINFORCED PROTECTIVE MEMBRANE

(71) Applicant: DMX Plastics Limited, Brampton (CA)

(72) Inventor: Steve Sennik, Thornhill (CA)

(73) Assignee: DMX PLASTICS LIMITED, Brampton (CA)

(21) Appl. No.: 13/692,335

(22) Filed: Dec. 3, 2012

Related U.S. Application Data
(60) Provisional application No. 61/566,491, filed on Dec. 2, 2011.

(51) Int. Cl. B32B 3/28; B32B 5/02

(52) U.S. Cl. CPC B32B 3/28; B32B 5/028
USPC 428/175; 442/1; 156/220

(57) ABSTRACT

A reinforced protective membrane comprises a water-resistant sheet and a reinforcing netting joined to the water-resistant sheet. The netting may be at least partially embedded in the water-resistant sheet. The reinforced protective membrane may also have a plurality of dimples formed therein. Each dimple may have a recess bounded by a dimple wall, and each dimple may have a dimple opening along a planar side of the water-resistant sheet that leads to the recess. The reinforcing netting may be joined to the water-resistant sheet such that the dimple opening is free from obstruction by the reinforcing netting.

This application claims the benefit of Provisional Application Ser. No. 61/566,491, filed Dec. 2, 2011, which is hereby incorporated herein by reference.

### FIELD

The teaching herein relates generally to reinforced protective membranes that can be used, for example, to protect a foundation wall of a basement and inhibit water penetration therethrough.

### BACKGROUND

U.S. Pat. No. 4,956,951 (Kannankeril) discloses a laminated sheet for an underground drainage system for a basement. The laminated sheet includes a layer of polystyrene and at least one layer of a polyolefin laminated to one side of the polystyrene layer. The laminated sheet is molded so as to include an array of spaced apart projections extending laterally outwardly from one side of the laminated sheet thereby forming a series of drainage channels.

U.S. Pat. No. 7,698,858 (Schroer et al.) discloses a studded membrane for protecting buildings. The studded membrane has a drainage and slip surface formed on the reverse side thereof. According to Schroer et al., this ensures that water is drained between the studded membrane and the exterior surface of the building.

U.S. Patent Application Publication No. 2006/0201092 (Saathoff) discloses a carrier tile consisting of film-like plastic for a floor, wall or ceiling structure, and in particular, a tile-clad wall or floor structure. The film-like tile has a multiplicity of chambers formed by depressions. The outer end faces of the depressions form a first tile side. The depressions are designed to receive a curing contact means, such as mortar or adhesive, for forming a contact layer with the surface cladding to be applied and with a net-like fabric or nonwoven arranged on the first tile side. The chambers between the first and an opposite tile side have an undercut-free wall portion. A net-like fabric overlapping the depressions is provided on the opposite tile side.

### SUMMARY

The following summary is intended to introduce the reader to this specification but not to define any invention.

According to one aspect, a reinforced protective membrane comprises a water-resistant sheet, and a reinforcing netting joined to the water-resistant sheet. The reinforced protective membrane has a plurality of dimples formed therein. Each dimple has a recess bounded by a dimple wall, and each dimple has a dimple opening along a planar side of the water-resistant sheet that leads to the recess. The dimple opening is free from obstruction by the reinforcing netting.

The reinforcing netting may extend into the recess along the dimple wall and may be joined thereto.

The dimple wall of each dimple may include a sidewall extending away from the planar side of the water-resistant sheet to an end wall. Furthermore, the reinforcing netting may extend along the sidewall and the end wall and may be joined thereto.

The reinforcing netting may be at least partially embedded within the water-resistant sheet.

The reinforcing netting may be fused to the water-resistant sheet.

The reinforcing netting may be joined to the water-resistant sheet across a continuous area. The continuous area may span across the water-resistant sheet.

The water-resistant sheet and the reinforcing netting may be made from deformable materials. The reinforcing netting may be made from polypropylene, and the water-resistant sheet may be made from polypropylene.

The reinforcing netting may include a plurality of reticulated strands woven together.

The reinforcing netting may include a plurality of reticulated strands fused together.

The reinforced protective membrane may be semi-rigid.

The water-resistant sheet may have a thickness of less than about 25 mils.

According to another aspect, a reinforced protective membrane comprises a water-resistant sheet having a thickness and a reinforcing netting at least partially embedded within the thickness of the water-resistant sheet.

The reinforced protective membrane may have a plurality of dimples formed therein. Each dimple may have a recess bounded by a dimple wall, and each dimple may have a dimple opening along a planar side of the water-resistant sheet that leads to the recess. Furthermore, the reinforcing netting may extend into the recess along the dimple wall and may be at least partially embedded therein.

The reinforcing netting may be at least partially embedded into the water-resistant sheet across a continuous area.

The reinforced protective may be semi-rigid.

According to another aspect, a method of manufacturing a reinforced protective membrane comprises joining a reinforcing netting to a water-resistant sheet, and forming a plurality of dimples in the joined netting and sheet. Each dimple has a recess bounded by a dimple wall, and each dimple has a dimple opening along a planar side of the water-resistant sheet that leads to the recess. The dimple opening is free from obstruction by the reinforcing netting.

The joining step may be performed downstream of an extrusion die from which the water-resistant sheet emerges.

The joining step may include pressing the reinforcing netting against the water-resistant sheet to at least partially embed the reinforcing netting into the water-resistant sheet.

The joining step may be completed while the water-resistant sheet is semi-molten.

The joining step may include fusing the reinforcing netting to the water-resistant sheet.

The forming step may occur after the joining step.

The forming step may include passing the reinforced protective membrane through a die having recesses corresponding to outer surfaces of the dimples. The forming step may also include stretching the reinforcing netting and the water-resistant sheet so as to bear against inner surfaces of the recesses of the die. The forming step may include vacuum forming the plurality of dimples.

According to another aspect, a method of manufacturing a reinforced protective membrane comprises embedding a reinforcing netting at least partially into a water-resistant sheet so as to provide the reinforced protective membrane.

The method may further comprise forming a plurality of dimples into the reinforced protective membrane.

The embedding step may be performed downstream of an extrusion die from which the water-resistant sheet emerges.

The embedding step may include pressing the reinforcing netting against the water-resistant sheet. The pressing step may include passing the reinforcing netting and the water-resistant sheet between opposed nip rollers.

The embedding step may be completed while the water-resistant sheet is semi-molten.

According to another aspect, a method of protecting a subterranean structure comprises positioning a water-resistant sheet against a surface of the subterranean structure, and reinforcing the water-resistant sheet with a reinforcing netting such that the reinforcing netting is joined to the water-resistant sheet so as to provide a reinforced protective membrane. The reinforced protective membrane has a plurality of dimples formed therein, each dimple having a recess bounded by a dimple wall, and each dimple has a dimple opening along a planar side of the water-resistant sheet that leads to the recess. The dimple opening is free from obstruction by the reinforcing netting.

The reinforcing step may occur before the positioning step.

According to another aspect, there is a method of protecting a subterranean structure. The method comprises positioning a water-resistant sheet against the subterranean structure. The water-resistant sheet has a thickness. The method also comprises reinforcing the water-resistant sheet with a reinforcing netting such that the reinforcing netting is at least partially embedded within the thickness of the water-resistant sheet.

The reinforcing step may occur before the positioning step.

Other aspects and features of the present specification will become apparent, to those ordinarily skilled in the art, upon review of the following description of the specific examples of the specification.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example of a reinforced protective membrane;

FIG. 2 is a top plan view of the reinforced protective membrane of FIG. 1;

FIG. 3 is a cross-sectional view of the reinforced protective membrane of FIG. 1 along the line 3-3;

FIG. 4 is a cross-sectional view of another example of a reinforced protective membrane;

FIG. 5 is a cross-sectional view of another example of a reinforced protective membrane;

FIG. 6 is a perspective view of another example of a reinforced protective membrane;

FIG. 7 is a schematic process diagram showing a method of manufacturing a reinforced protective membrane; and

FIG. 8 is a side elevation view of two protective membranes positioned against subterranean structural surfaces, namely, one membrane positioned against a foundation wall and another membrane positioned against a foundation floor.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

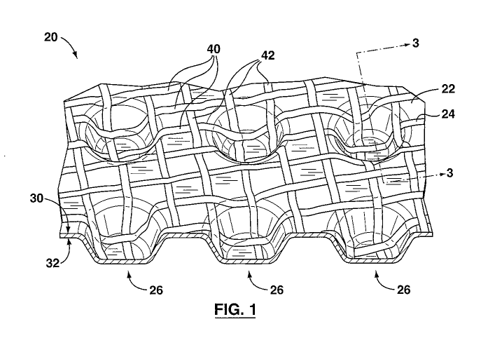

Referring to FIG. 1, there is a reinforced protective membrane 20, which can be used to protect a foundation wall of a basement or another subterranean structure such as a basement floor. The reinforced protective membrane 20 includes a water-resistant sheet 22, and a reinforcing netting 24 joined to the water-resistant sheet 22. The reinforced protective membrane 20 also has a plurality of dimples 26 formed therein. In the illustrated example, the water-resistant sheet 22 has a planar side 30, and a dimpled side 32 opposite the planar side 30. The dimples 26 form openings in the planar side 30 of the sheet 22 and project outwardly from the dimpled side 32 of the sheet 22.

The water-resistant sheet 22 may be made from a material that is impervious to moisture. In the example illustrated, the water-resistant sheet 22 is generally impervious to water and can be used as a moisture barrier for a subterranean structural surface such as a foundation wall. The material from which the water-resistant sheet 22 is made may also be deformable, which can facilitate the formation of the dimples 26 in the sheet 22. Materials from which the water-resistant sheet 22 may be made include, for example, polypropylene, polyethylene, high density polyethylene, and/or other plastics.

In some examples, the sheet 22 may be a polypropylene sheet having an area density of less than about 65-g/sq-ft and a thickness of less than about 25-mils. More particularly, the sheet 22 may be a polypropylene sheet having an area density of about 40-g/sq-ft and a thickness of about 15-mils. In other examples, the sheet 22 may have an area density of greater than 65-g/sq-ft or a thickness greater than 25-mils.

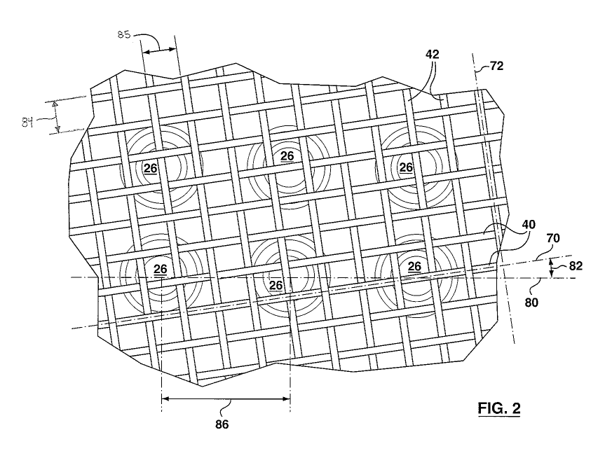

Referring to FIG. 2, the reinforcing netting 24 includes a plurality of reticulated strands including first strands 40 extending generally parallel to a first axis 70 and second strands 42 generally parallel to a second axis 72. The second axis 72 can be generally perpendicular to the first axis 72.

As shown in FIGS. 1 and 2, the strands 40, 42 may be woven together such that the first strands 40 define warp strands, and the second strands 42 define weft strands that are interwoven with the warp strands. In some examples, the reinforcing netting 24 may have a non-woven construction. For example, the netting 24 may include reticulated strands 40, 42 that are fused together at the intersections between the strands 40, 42.

The strands 40, 42 of the netting 24 are generally made from a material that can help the netting 24 reinforce the water-resistant sheet 22. Furthermore, the strands 40, 42 may be made from deformable materials such that the dimples 26 may be formed in the protective membrane 20 after joining the reinforcing netting 24 to the water-resistant sheet 22. Materials from which the strands 40, 42 can be made include, for example, polypropylene, polyethylene, high density polyethylene, nylon, and other plastics. In some examples the strands 40, 42 may be made from other materials such as fiberglass and Kevlar™, which might not be deformable.

In some examples, the netting 24 may include polypropylene strands 40, 42 and the netting 24 may have an area density of about 14-g/sq-ft. In other examples, the netting 24 may have an area density smaller or greater than 14-g/sq-ft.

In some examples, the netting 24 may be made from the same material as the sheet 22 while still providing reinforcement. For example, the inventors believe that the strands 40, 42 provide concentrated lines of oriented material, the direction of orientation being parallel to the strands 40, 42. This orientation of material in each strand 40, 42 may reinforce the sheet 22 and enhance the ability of the protective membrane 20 to withstand tensile and/or compressive forces acting along the strands 40, 42. Accordingly, even when the sheet 22 and netting 24 are made from the same material, the strands 40, 42 may significantly reinforce the sheet 22.

Referring again to FIG. 2, in some examples, the netting 24 may be angularly offset relative to the alignment of the dimples 26. For example, the dimples 26 may be aligned in columns and rows such that one or more of the rows or columns are aligned along a third axis 80 that is angularly offset from the first and/or second axes 70, 72 by an oblique angle. For example, the strands 40 oriented along the first axis 70 may be angularly offset from the third axis 80 by an offset angle 82. The offset angle 82 may be about 10-degrees. In some examples, the offset angle 82 may be larger or smaller than 10-degrees. Providing the angular offset can help enhance material properties along certain directions that are angularly offset from the rows and columns of the dimples 26. In other examples, the strands 40, 42 may be parallel with the rows and columns of dimples 26.

Referring still to FIG. 2, adjacent first strands 40 may be spaced apart from each other by a first strand spacing 84, and adjacent second strands 42 may be spaced apart from each other by a second strand spacing 85. The first strand spacing 84 may be generally equal to the second strand spacing 85. In some examples, the strand spacing 84, 85 may be selected to be smaller than a diameter of the openings of the dimples 26. This can help to ensure that portions of the strands 40, 42 extend into the dimples 26. Furthermore, in some examples, the strand spacing 84, 85 may be selected to be smaller than a dimple spacing 86 between adjacent dimples 26. This can help to ensure that portions of the strands 40, 42 extend along non-dimpled portions of the sheet 22 (i.e. between adjacent dimples 26).

In some examples, the strand spacing 84, 85 may be between about 5-millimeters and about 15-millimeters, the diameter of the openings of the dimples 26 may be between about 15-millimeters and about 25-millimeters, and the dimple spacing 86 may be between about 25-millimeters and about 35-millimeters on center. More particularly, in some examples, the strand spacing 84, 85 may be about 8-millimeters, the diameter of the openings of the dimples 26 may be about 18-millimeters, and the dimple spacing 86 may be about 28-millimeters on center. In other examples, one or more of the strand spacing 84, 85, the diameter of the openings of the dimples 26, and the dimple spacing 86 may have other dimensions, which may be smaller or larger than the dimensions provided above.

In some examples, the netting 24 may include a carrier film (not shown) applied to the interwoven strands 40, 42. The carrier film may help maintain the spacing between adjacent strands 40, 42. The carrier film may be made from the same material as the strands themselves (e.g. polypropylene), or other materials, which may include plastic films, coatings, and adhesives. In some examples, the carrier film may be a 5-mil poly-carrier.

As mentioned above, the reinforcing netting 24 is joined to the sheet 22. For example, with reference to FIG. 3, the netting 24 may have a proximate or inner netting surface 34 directed towards a proximate or inner sheet surface 36 of the sheet 22. The inner netting surface 34 may include the surfaces of the strands directed towards the sheet 22. Furthermore, if the netting 24 includes the carrier film, the inner netting surface 34 may also include surfaces of the carrier film that are directed towards the sheet 22. As shown in the example illustrated, the entire inner netting surface 34 may be joined to the sheet 22 in the sense that the netting 24 is adjacent to the sheet 22. Furthermore, the netting 24 may physically touch the sheet 22 or share a common boundary therewith.

As shown in FIGS. 1 and 3, the reinforcing netting 24 may be joined to the planar side 30 of the sheet 22 (e.g. such that the inner sheet surface 36 corresponds to the surface of the planar side 30 of the sheet 22), however, in other examples, the netting 24 may be joined to the dimpled side 32 of the sheet 22 (e.g. such that the inner sheet surface 36 corresponds to the surface of the dimpled side 32 of the sheet 22).

Joining the netting 24 to the sheet 22 can help improve the strength of the protective membrane 20. For example, the netting 24 may reinforce areas of the sheet that have stress concentrations, which might otherwise be vulnerable to tearing, puncturing or other failures within the sheet 22. Such stress concentrations can arise during formation of the dimples 26. For example, the stress concentrations may include stretch lines that are created between dimples 26 when the dimples 26 are formed. Non-reinforced dimpled sheets having these stretch lines often have lower tensile strength in comparison to the reinforced protective membrane 20 described herein, and the stretch lines can present quality defects that lead to failure of such non-reinforced dimpled sheets.

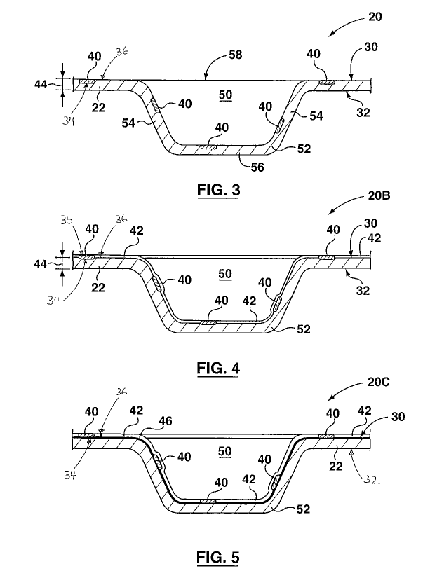

Referring now to FIGS. 3-5, the netting 24 may be joined to the sheet 22 using a number of techniques. For example, as shown in FIGS. 3 and 4, the netting 24 may be embedded into the sheet 22. More particularly, the sheet 22 has a thickness 44, and the netting 24 is at least partially embedded within the thickness 44 of the sheet 22. Embedding the netting 24 into the sheet 22 can provide a reinforced protective membrane 20 that is strong, resistant to tearing and deformation, and semi-rigid, yet pliable enough to be rolled up, for example, to store or transport the protective membrane 20.

Referring to FIG. 3, the netting 24 may be completely embedded within the thickness 44 of the sheet 22, for example, such that outer facing surfaces of the strands 40, 42 are substantially flush with the planar side 30 of the sheet 22. In some examples, the netting 24 may be completely embedded into the sheet 22 such that the netting 24 is located between the sides 30, 32 of the sheet 22. Completely embedding the netting 24 into the sheet 22 may cause a number of bumps or protrusions (not shown) to be formed on the dimpled side 32 of the sheet 22.

Referring to FIG. 4, there is another reinforced protective membrane 20B, which is similar in many respects to the reinforced protective membrane 20. In the example of the membrane 20B, the netting 24 is partially embedded within the sheet 22. For example, outward facing netting surfaces 35 of the strands 40, 42 protrude outward from the planar side 30 of the sheet 22 resulting in a plurality of bumps along the planar side 30 of the sheet 22.

Embedding the netting 24 deeper into the sheet 22 can increase strength, while keeping the protective membrane 20 relatively thin, which may reduce material costs for the protective membrane 20. Furthermore, embedding the netting 24 deeper into the sheet 22 can enhance the joint strength between the netting 24 and the sheet 22, which may reduce the likelihood of the netting 24 becoming separated from the sheet 22.

In some examples, embedding the netting 24 into the sheet 22 may include applying pressure to the netting 24 and the sheet 22. In some examples, heat may be used to facilitate embedding the netting 24 into the sheet 22 and/or to fuse the netting 24 to the sheet 22.

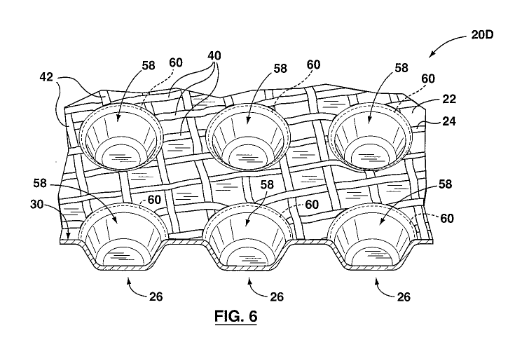

As another example, the netting 24 may be joined to the sheet 22 by bonding the netting 24 to the sheet 22. For example, with reference to FIG. 5, there is another reinforced protective membrane 20C, which is similar in many respects to the reinforced protective membrane 20. In the example of the membrane 20C, the netting 24 is bonded to the sheet 22, for example, using an adhesive 46. As shown, the adhesive 46 may be applied to the planar side 30 of the sheet 22 so as to bond the netting 24 to the planar side 30 of the sheet 22.

In some examples, the netting 24 may be joined to the sheet 22 across a continuous area, as opposed to being joined to the sheet 22 at discrete locations. In some examples, the netting 24 may be joined to the sheet across the entire span of the sheet 22. For example, the netting 24 may be joined to the sheet 22 along both dimpled and non-dimpled portions of the sheet 22 as will be described below.

Referring again to FIG. 3, each dimple 26 has a recess 50 bounded by a dimple wall 52. The dimple wall 52 may include a sidewall 54 extending away from the planar side 30 of the sheet 22 to an end wall 56, which defines the base of the recess 50. As shown in FIG. 3, the dimples 26 may have a frustoconical shape. In other examples, the dimples 26 may have other shapes, such as, for example, a cylindrical, convex, or rectangular shape.

Each dimple 26 also has a dimple opening 58 along the planar side 30 of the sheet 22. The dimple opening 58 may be defined along the same plane as the planar side 30. The dimple opening 58 leads to the recess 50. In some examples, this can allow soil and other material to enter the recess 50 from the planar side 30 and backfill the recess 50. Backfilling the recesses 50 can help increase the rigidity and stability of the protective membrane 20 once installed.

In some examples, the netting 24 may be joined to the sheet 22 in a manner such that the dimple opening 58 is free from obstruction by the netting 24. For example, as shown in FIG. 3, the strands 40, 42 of the netting 24 may extend into the recess 50 along the dimple wall 52 such that the strands 40, 42 of the netting 24 do not obstruct the dimple opening 58. The strands 40, 42 may also be joined to the dimple wall 52 (e.g. to the sidewall 54, end wall 56, or both).

With this configuration, the dimple openings 58 remain clear of, and unobstructed by, the strands 40, 42. In some examples, this can enable soil and other material to backfill the recesses 50. In contrast, if the strands 40, 42 were to extend over the recesses 50 and obstruct the dimple opening 58, the strands 40, 42 might inhibit or prevent material from backfilling into the recesses 50. Joining the netting 24 to the sheet 22 in a manner that does not obstruct the openings 58 can also inhibit or prevent objects from catching on the netting 24 and pulling the netting 24 off the sheet 22.

In some examples, the membrane 20 may have strands 40, 42 joined to the sheet at non-dimpled locations between the openings 58, and the membrane 20 may be free of strands joined to the sidewalls 54 and end walls 56 of the recesses 50. For example, with reference to FIG. 6, there is another reinforced protective membrane 20D, which is similar in many respects to the reinforced protective membrane 20. In the example of the membrane 20D, a plurality of openings 60 are provided in the netting 24. The openings 60 may be aligned with the locations of the dimples 26, for example, prior to forming the dimples 26. This can leave the sidewalls 54 and end walls 56 free of any strands joined thereto.

Even though the netting 24 does not extend into the dimples 26, the entire inner netting surface of the netting 24 is still joined to the inner sheet surface of the sheet 22 across a continuous area, namely, across the non-dimpled portions located between adjacent dimples 26 on the planar side 30 of the sheet 22.

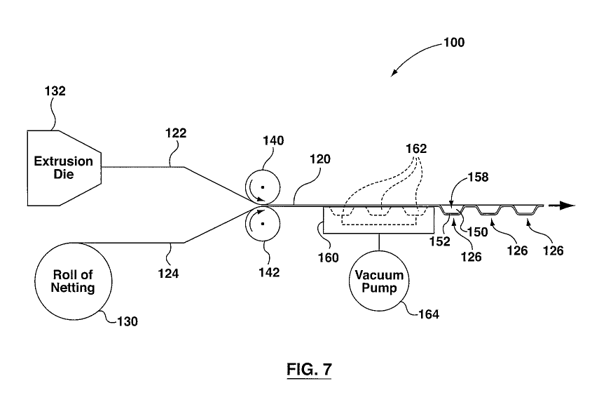

Referring now to FIG. 7, there is a process diagram that illustrates a method 100 of manufacturing a reinforced protective membrane, such as the protective membrane 20.

The method 100 includes joining a reinforcing netting 124 to a water-resistant sheet 122 so as to provide a reinforced protective membrane 120. As shown in FIG. 7, the netting 124 may be provided from a roll of netting material 130, and the sheet 122 may be extruded by passing raw material through an extrusion die 132.

In some examples, the sheet 122 and netting 124 may be provided from other sources. For example, the netting 124 may be provided from an upstream loom that weaves strands together so as to form the netting 124. Furthermore, the sheet 122 may be formed using a pultrusion process, or the sheet 122 may be provided from a roll of water-resistant sheet.

The netting 124 may be joined to the sheet using a number of techniques such as, for example, embedding, fusing, or bonding the netting 124 to the sheet 122. As shown in FIG. 7, the netting 124 may be embedded into the sheet 122 by pressing the netting 124 and sheet 122 between opposed nip rollers 140, 142.

The rollers 140, 142 may be spaced apart by a distance selected to embed the netting 124 into the sheet 122 to some particular extent. For example, the distance between the rollers 140, 142 may be less than or equal to the thickness of the sheet 122, which may completely embed the netting 124 into the sheet 122, for example, as shown in FIG. 3. In some examples, the rollers 140, 142 may be spaced apart further than the thickness of the sheet 122, which may partially embed the netting 124 into the sheet 122, for example, as shown in FIG. 4.

The distance between the rollers 140, 142 can also be selected to reduce the thickness of the sheet 122 and thereby reduce the area density of the sheet 122. Reducing the thickness and/or area density of the sheet 122 can decrease material costs for the protective membrane 120.

In some examples, the rollers 140, 142 may be rotated so as to feed the material downstream. Furthermore, the rollers 140, 142 may be rotated at a speed selected to provide a tensile force that stretches the sheet 122 and further reduces the thickness thereof.

In some examples, the thickness of the sheet 122 may be reduced in other ways, for example, by providing a thinner sheet prior to joining the netting 24 to the sheet 22. For example, the rate at which the melt passes through the extrusion die 132 may be increased so as to extrude a thinner sheet 122. Increasing the flow rate of the melt through the extrusion die 132 can also speed up the extrusion process. This can enable production of more protective membranes 120 per unit of time and may further decrease manufacturing costs of the membranes 120.

In some examples, the netting 124 may be joined to the sheet 122 downstream of the extrusion die 132 from which the water-resistant sheet 122 emerges. For example as shown in FIG. 7, the rollers 140, 142 may be positioned downstream of the extrusion die 132.

In some examples, the netting 124 may be embedded into the sheet 122 while the sheet 122 is semi-molten. For example, the sheet 122 may be semi-molten as the sheet 122 emerges from the extrusion die 132 and the sheet 122 may remain semi-molten for some time thereafter. Furthermore, the rollers 140, 142 may press the netting 124 into the sheet 122 while the sheet 122 is semi-molten.

In some examples, the sheet 122 may be allowed to partially solidify prior to joining the netting 124 to the sheet 122. For example, the extrusion die 132 and the rollers 140, 142 may be spaced apart by a distance selected to permit the sheet 122 to cool and at least partially solidify prior to embedding the netting 24 into the sheet 122. Partially solidifying the sheet 122 can reduce the likelihood of the sheet 122 being damaged or torn while being pressed between the rollers 140, 142.

In some examples, the step of joining the netting 124 to the sheet 122 may include fusing the netting 124 with the sheet 122. For example, the semi-molten sheet 122 may be hot enough to partially melt the netting 124 when the rollers 140, 142 press the netting 124 against the sheet 122. As another example, there may be a heater upstream of the rollers 140, 142 for heating the sheet 122 or the netting 124 to a temperature sufficient to fuse the netting 124 to the sheet 122. The particular temperature for fusing the netting 124 to the sheet 122 may depend on the amount of pressure applied by the rollers 140, 142, and the specific materials used to make the netting 124 and the sheet 122.

The method 100 may also include forming a plurality of dimples 126 into the reinforced protective membrane 120. The dimples 126 may be similar to the dimples 26 described above. For example, each dimple 126 may have a recess 150 bounded by a dimple wall 152, and each dimple 126 may have a dimple opening 158 along a planar side of the water-resistant sheet 122.

The dimples 126 may be formed such that the reinforcing netting 124 does not obstruct the dimple opening 158. For example, as mentioned above, the dimples 126 may be formed such that the netting 124 extends into the recesses 150 along the dimple walls 152, leaving the dimple openings 158 free from obstruction by the reinforcing netting 124. This may be achieved, for example, by forming the dimples 126 after joining the netting 124 to the sheet 122.

The dimples 126 may be formed using a number of techniques. For example, the reinforced protective membrane 120 may pass through a dimple forming die 160 having a plurality of recesses 162 corresponding to outer surfaces of the dimples 126. The dimples 126 can then be formed by stretching the reinforcing netting 124 and the water-resistant sheet 122 so as to bear against inner surfaces of the recesses 162 of the dimple forming die 160. One way of doing this is by vacuum forming the dimples 126. For example, a vacuum pump 164 may apply negative pressure to the dimple forming die 160 so as to draw the protective membrane 120 into the recesses 162 and thereby stretch the netting 124 and the sheet 122 into the shape of the dimples 126.

In other examples, the dimples 126 may be formed using other techniques, for example, by pressing the netting 124 and the sheet 122 into the recesses 162 using a machine press.

In some examples, the netting 124 may be joined to the sheet 122 while forming the dimples 126. For example, the machine press may form the dimples and join the netting 124 to the sheet.

In some examples, the dimples 126 may be formed prior to joining the netting 124 to the sheet 122. For example, the netting 124 may be bonded to the sheet 122 using an adhesive after the dimples 126 have been formed in the sheet 122.

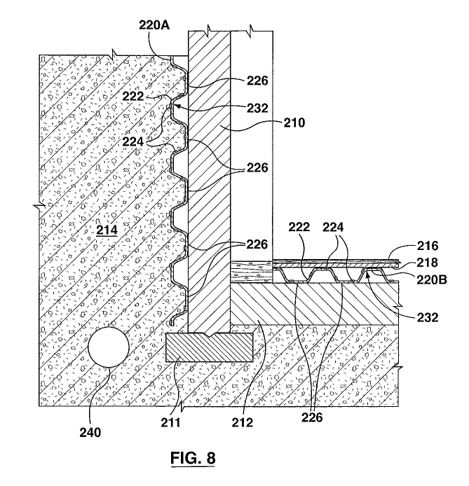

Referring now to FIG. 8, there are two reinforced protective membranes installed and positioned against two subterranean structural surfaces, namely, a first protective membrane 220A is positioned against an exterior surface of a foundation wall 210, and a second protective membrane 220B is positioned against an interior surface of a foundation floor 212. The protective membranes 220A, 220B are generally similar to the protective membrane 20 described above, and similar features are identified by similar reference numerals incremented by 200.

Each protective membrane 220A, 220B includes a water-resistant sheet 222 and a reinforcing netting 224 that is joined to the sheet 222. The sheets 222 of each protective membrane 220A, 220B are generally reinforced by the netting 224 prior to positioning the protective membranes 220A, 220B against the structural surfaces 210, 212. For example, the sheet 222 may be reinforced using the method 100 described above prior to positioning the protective membrane 220 against the structural surfaces 210, 212. In other examples, the netting 224 may be applied to a sheet that is already in place, for example, by bonding the netting 224 to the sheet 222 using adhesive.

Each protective membrane 220A, 220B includes a plurality of dimples 226 formed therein. Each dimple 226 also has a recess bounded by a dimple wall. The dimples 226 of each protective membrane 220A, 220B may be spaced apart. The spacing between the dimples 226 may provide drainage passageways between the dimpled side 232 of the sheet 222 and the subterranean structural surfaces 210, 212.

As shown in the illustrated example, the first protective membrane 220A is positioned vertically against the exterior surface of the foundation wall 210. The foundation wall 210 may be supported by a footing 211, and a foundation floor 212 may be located above the footing 211. There may also be a drainage pipe 240 near the footing 211. The drainage pipe 240 may direct water and other types of moisture away from the foundation wall 210 and the footing 211.

In some examples, the recesses of the first protective membrane 220A may be backfilled, which may help hold the first protective membrane 220A in place against the foundation wall 210. For example, as shown in FIG. 8, soil 214 and other material may backfill the recesses formed by the dimples 226. The reinforced protective membrane 220A may resist punctures or tears that could be caused by, for example, by rocks or other components in the backfill. Nevertheless, if a puncture or tear is generated, the strands in the netting 224 can arrest further progression of the puncture or tear.

The second protective membrane 220B may be positioned horizontally against the interior surface of the foundation floor 212. As shown, flooring may be laid on top of the second protective membrane 220B. For example, the flooring may include a wooden laminate flooring 218 with a substrate such as a foam underlay 218 positioned between laminate flooring 218 and the second protective membrane 220B. In other examples, the second protective membrane 220B may support other types of flooring such as carpet, ceramic tile, or vinyl.

Reinforcing the second protective membrane 220B with the netting 224 can be beneficial because the reinforcement might allow the dimples 224 to resist deformation caused by compression, for example, due to the weight of the flooring and other objects that might be supported by the flooring.

Testing was completed on samples made according with one or more of the examples described above. As will be described below, the testing showed that these samples had improved strength compared non-reinforced protective membranes.

Tensile testing was conducted using dimpled sheet samples having a size of 2-inches wide and 30 inches long. A first non-reinforced sample included a polypropylene water-resistant sheet having an area density of 65-g/sq-ft and formed with 18-millimeter diameter dimples spaced apart equally at 28-millimeters on-center. A second sample was prepared similarly as the first sample, however, the second sample had a lower area density of 40-g/sq-ft. After forming the dimples, the lower density sample had a number of stretch lines between the dimples. The inventors believe that the stretch lines represent points of weakness within the sheet. A third sample was prepared in accordance with one or more examples of a reinforced protective membrane as described herein. The third sample included a similar sheet as the second sample (e.g. including the stretch lines), and a reinforcing netting joined to the sheet. The netting included reticulated strands made from polypropylene and woven together with a spacing of 8-millimeters between strands. The netting had an area density of about 14-g/sq-ft. The netting was embedded into the sheet by pressing them between opposed nip rollers while the sheet was semi-molten. The dimples were vacuum formed after joining the netting to the sheet.

During testing, all three samples were suspended lengthwise from an upper end, and an 80-pound mass was attached to the lower end of each sample. A sample passed the test if it held the weight for 10-minutes. The results of the testing are shown in Table 1.

TABLE 1
Results of Tensile Testing

| SAMPLE NO. | RESULT |
|---|---|
| Sample #1: 65-g/sq-ft sheet without netting | Passed |
| Sample #2: 40-g/sq-ft sheet without netting | Failed |
| Sample #3: 40-g/sq-ft sheet with netting | Passed |

The first sample passed, however, the second sample failed. The inventors believe that the stretch lines in the second sample represented stress concentrations that led to early failure of the sample.

Surprisingly, the third sample passed the test even though similar stretch lines were present in the sheet. The inventors found that the reinforcing netting increased the tensile strength of the membrane to an acceptable level of strength, even though the sheet was substantially thinner than that of the first sample, and contained many stretch lines between the dimples.

Furthermore, and also unexpectedly, the reinforced protective membrane of the third sample also appeared to have enhanced compression strength. In particular, the dimples of the second sample (without the reinforcing netting) could be easily deformed by pressing the dimples inward from the end wall toward the planar side of the sheet. In contrast, the dimples of the third sample (with the reinforcing netting) could not be deformed using a similar force.

The third sample provided a semi-rigid dimpled membrane that generally retained its shape and dimensions laterally (e.g. the membrane could not be collapsed laterally in the plane of the membrane and the dimples retained their shape and dimension), however, the membrane was still pliable or flexible enough to be rolled up.

While the above description provides examples of one or more processes or apparatuses, it will be appreciated that other processes or apparatuses may be within the scope of the accompanying claims.

1. A reinforced protective membrane comprising:
(a) a water-resistant sheet; and
(b) a reinforcing netting joined to the water-resistant sheet;
(c) wherein the reinforced protective membrane has a plurality of dimples formed therein, each dimple having a recess bounded by a dimple wall, and each dimple having a dimple opening along a planar side of the water-resistant sheet that leads to the recess, and wherein the dimple opening is free from obstruction by the reinforcing netting.

2. The reinforced protective membrane of claim 1, wherein the reinforcing netting extends into the recess along the dimple wall and is joined thereto.

3. The reinforced protective membrane of claim 2, wherein the dimple wall of each dimple includes a sidewall extending away from the planar side of the water-resistant sheet to an end wall, and wherein the reinforcing netting extends along the sidewall and the end wall and is joined thereto.

4. The reinforced protective membrane of claim 1, wherein the reinforcing netting is at least partially embedded within the water-resistant sheet.

5. The reinforced protective membrane of claim 1, wherein the reinforcing netting is fused to the water-resistant sheet.

6. The reinforced protective membrane of claim 1, wherein the water-resistant sheet and the reinforcing netting are made from deformable materials.

7. The reinforced protective membrane of claim 1, wherein the reinforcing netting includes a plurality of reticulated strands woven together.

8. The reinforced protective membrane of claim 1, wherein the reinforcing netting includes a plurality of reticulated strands fused together.

9. The reinforced protective membrane of claim 1, wherein the reinforced protective membrane is semi-rigid.

10. The reinforced protective membrane of claim 1, wherein the water-resistant sheet has a thickness of less than about 25 mils.

11. A reinforced protective membrane comprising:
(a) a water-resistant sheet having a thickness; and
(b) a reinforcing netting at least partially embedded within the thickness of the water-resistant sheet.

12. The reinforced protective membrane of claim 11, wherein the reinforced protective membrane has a plurality of dimples formed therein.

13. The reinforced protective membrane of claim 12, wherein each dimple has a recess bounded by a dimple wall, and each dimple has a dimple opening along a planar side of the water-resistant sheet that leads to the recess.

14. The reinforced protective membrane of claim 13, wherein the reinforcing netting extends into the recess along the dimple wall and is at least partially embedded therein.

15. The reinforced protective membrane of claim 11, wherein the reinforcing netting is at least partially embedded into the water-resistant sheet across a continuous area.

16. A method of manufacturing a reinforced protective membrane, the method comprising:
(a) joining a reinforcing netting to a water-resistant sheet so as to provide the reinforced protective membrane; and
(b) forming a plurality of dimples into the reinforced protective membrane, each dimple having a recess bounded by a dimple wall, and each dimple having a dimple opening along a planar side of the water-resistant sheet that leads to the recess, and wherein the dimple opening is free from obstruction by the reinforcing netting.

17. The method of claim 16, wherein the joining step is performed downstream of an extrusion die from which the water-resistant sheet emerges.

18. The method of claim 16, wherein the joining step includes pressing the reinforcing netting against the water-resistant sheet to at least partially embed the reinforcing netting into the water-resistant sheet.

19. The method of claim 16, wherein the joining step is completed while the water-resistant sheet is semi-molten.

20. The method of claim 16, wherein the joining step includes fusing the reinforcing netting to the water-resistant sheet.
